(19) United States
(12) Patent Application Publication
(10) Pub. No.: US 2009/0295032 A1
(43) Pub. Date: Dec. 3, 2009

(54) Method of building three-dimensional object with modified ABS materials

(75) Inventor: Paul E. Hopkins, Savage, MN (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: Stratasys, Inc., Eden Prairie, MN (US)

(21) Appl. No.: 11/717,866

(22) Filed: Mar. 14, 2007

(51) Int. Cl. B28B 1/14

(52) U.S. Cl. 264/308

(57) ABSTRACT

A method for building a 3D object with an extrusion-based layered deposition system comprising feeding a modified ABS material to an extrusion head of the extrusion-based layered deposition system, melting the fed modified ABS material in the extrusion head under conditions that improve a response time of the extrusion head, and depositing the molten thermoplastic material in a layer-by-layer manner to form the 3D object.

### BACKGROUND

The present invention relates to the fabrication of three-dimensional (3D) objects using extrusion-based layered deposition systems. In particular, the present invention relates to the fabrication of 3D objects from build materials containing modified ABS materials.

An extrusion-based layered deposition system (e.g., fused deposition modeling systems developed by Stratasys, Inc., Eden Prairie, Minn.) is used to build a 3D object from a computer-aided design (CAD) model in a layer-by-layer manner by extruding a flowable build material. The build material is extruded through a nozzle carried by an extrusion head, and is deposited as a sequence of roads on a substrate in an x-y plane. The extruded build material fuses to previously deposited build material, and solidifies upon a drop in temperature. The position of the extrusion head relative to the base is then incremented along a z-axis (perpendicular to the x-y plane), and the process is then repeated to form a 3D object resembling the CAD model.

Movement of the extrusion head with respect to the base is performed under computer control, in accordance with build data that represents the 3D object. The build data is obtained by initially slicing the CAD model of the 3D object into multiple horizontally sliced layers. Then, for each sliced layer, the host computer generates a build path for depositing roads of build material to form the 3D object.

In fabricating 3D objects by depositing layers of build material, supporting layers or structures are typically built underneath overhanging portions or in cavities of objects under construction, which are not supported by the build material itself. A support structure may be built utilizing the same deposition techniques by which the build material is deposited. The host computer generates additional geometry acting as a support structure for the overhanging or free-space segments of the 3D object being formed. Support material is then deposited from a second extrusion tip pursuant to the generated geometry during the build process. The support material adheres to the build material during fabrication, and is removable from the completed 3D object when the build process is complete.

Build materials typically exhibit non-Newtonian flow characteristics, in which the build materials resist movement during an initial start up phase of an extrusion flow. Thus, a common issue with many 3D objects is the limitation in the response times of the extrusion heads due to the non-Newtonian flow characteristics. Such limitations may reduce the accuracy of the depositions, and are particularly observable with fine feature structures, where the amounts of build material deposited per layer are relatively small. Thus, there is a need for a method of building 3D objects that improves the response time with an extrusion head for depositing build materials.

### SUMMARY

The present invention relates to a method for building a 3D object with an extrusion-based layered deposition system. The method includes feeding a modified ABS material to an extrusion head of the extrusion-based layered deposition system, and melting the fed modified ABS material in the extrusion head under conditions that improve a response time of the extrusion head. The molten thermoplastic material is then deposited in a layer-by-layer manner to form the 3D object.

### BRIEF DESCRIPTION OF THE DRAWINGS

FIG. 1 is a perspective view of a build chamber of an extrusion-based layered deposition system, showing a 3D object being built pursuant to the present invention.

FIG. 2 is an expanded partial sectional view of an extrusion head build line of the extrusion-based layered deposition system.

FIG. 3 is a flow diagram of a method for building a 3D object with the extrusion-based layered deposition system.

FIGS. 4-7 are graphical representations of drive pressures versus extrusion rates for extrusion runs performed pursuant to the present invention, and comparative extrusion runs.

FIG. 8 is a graphical representation of drive pressure versus extrusion rate for extrusion runs performed pursuant to the present invention, and comparative extrusion runs.

### DETAILED DESCRIPTION

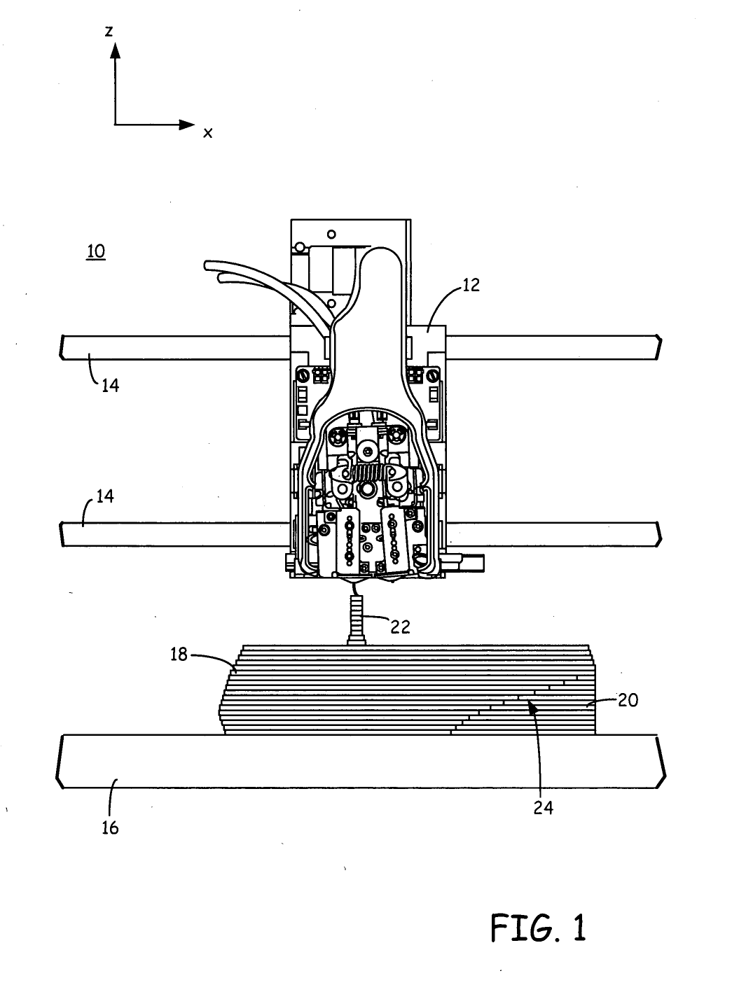

FIG. 1 is a perspective view of build chamber 10 of an extrusion-based layered deposition system, which includes extrusion head 12, guide rails 14, build platform 16, 3D object 20, and support structure 22. Suitable extrusion-based layered deposition systems that may incorporate build chamber 10 include fused deposition modeling systems commercially available under the trade designation “FDM” from Stratasys, Inc., Eden Prairie, Minn. Extrusion head 12 is a device configured to extrude flowable build material and support materials to respectively build 3D object 18 and support structure 20 in a layer-by-layer manner. Examples of suitable devices for extrusion head 12 are disclosed in LaBossiere, et al., U.S. Patent Application Publication No. 2007/0003656, and LaBossiere, et al., U.S. patent application Ser. No. 11/396,845.

Extrusion head 12 is supported within build chamber 10 by guide rails 14, which extend along an x-axis, and by additional guide rails (not shown) extending along a y-axis (not shown) within build chamber 10. Guide rails 14 and the additional guide rails allow extrusion head 12 to move in any direction in a plane along the x-axis and the y-axis. Build platform 16 is a working surface for building 3D object 18 and support structure 20, and is adjustable in height along a z-axis.

The build material used to build 3D object 18 is a modified ABS material capable of being extruded from extrusion head 12 with improved response times, thereby improving the accuracy of the deposition process. Examples of suitable modified ABS materials for use with the present invention include ABS materials modified with additional monomers, oligomers, and/or polymers, such as acrylate-based materials. Examples of suitable commercially available modified ABS materials include methylmethacrylate-modified ABS/poly(styrene-acrylonitrile) blends under the trade designation “CYCOLAC” ABS MG94-NA1000 from General Electrics Co., Pittsfield, Mass.

3D object 18 includes pin feature 22 and overhanging portion 24, where pin feature 22 is a multi-layer, fine feature structure having a small average cross section in the plane along the x-axis and the y-axis. Pin feature 22 is an example of a fine feature structure that may exhibit observable build inaccuracies when built with a standard ABS copolymer (e.g., an ABS copolymer commercially available under the trade designation “AG700 ABS” from The Dow Chemical Company, Midland, Mich.). For example, a standard ABS copolymer will result in visible inaccuracies when building a fine feature structure having at least one width of about 120 mils or less in the plane along the x-axis and the y-axis. This may detract the aesthetic and physical qualities of the resulting 3D object.

In contrast, pin feature 22 is built with greater deposition accuracy due to the improved response time obtained by depositing the modified ABS material from extrusion head 12. As a result, suitable cross-sectional dimensions for pin feature 22 in the plane along the x-axis and the y-axis include widths of about 120 mils or less, with particularly suitable widths ranging from about 60 mils to about 110 mils. Under processing conditions discussed below, such materials are capable of obtaining greater Newtonian-like properties (compared to a standard ABS copolymer), thereby improving the response times of extrusion head 12 when building 3D object 10. Additionally, the modified ABS materials are capable of providing 3D objects with good interlayer adhesion and part strengths.

Support structure 20 is built in a layer-by-layer manner on build platform with the use of the support material, thereby supporting. overhanging region 24 of 3D object 18. In addition to being deposited with increased response times, the modified ABS material is a suitable for use with water-soluble support materials commercially available under the trade designations “WATERWORKS” and “SOLUBLE SUPPORTS” from Stratasys, Inc., Eden Prairie, Minn. In addition, the modified ABS material is also suitable for use with break-away support material commercially available under the trade designation “BASS” from Stratasys, Inc., Eden Prairie, Minn., and those disclosed in Crump et al., U.S. Pat. No. 5,503,785. In comparison, a standard ABS copolymer exhibits a significant amount of adhesion to “BASS”-based support structures. The modified ABS material is substantially easier to break away from “BASS”-based support structures, while also allowing suitable adhesion during the build process.

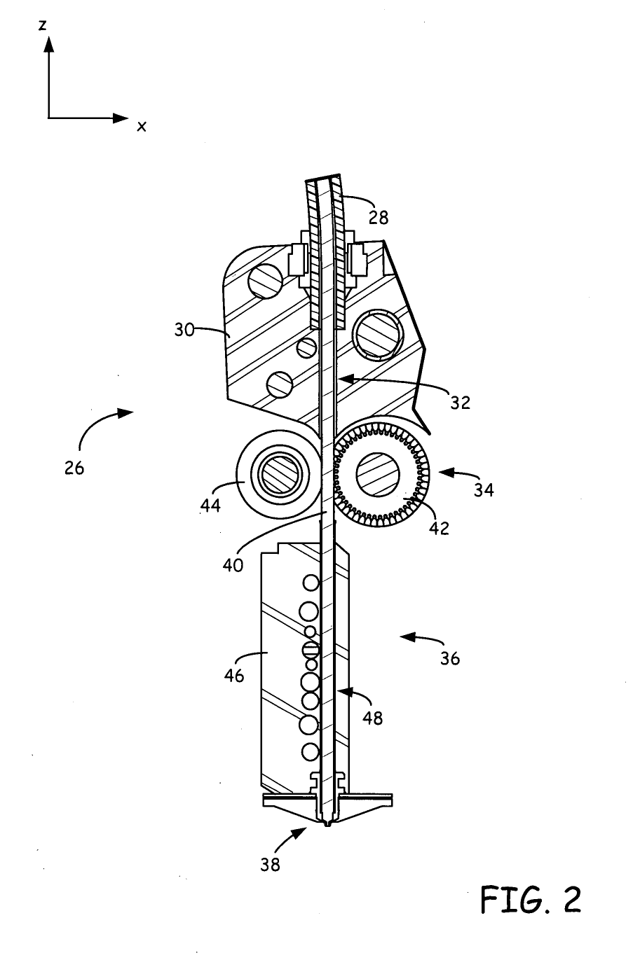

FIG. 2 is an expanded partial sectional view of build line 26 of extrusion head 12 (shown in FIG. 1) for extruding the modified ABS material to build 3D object 18 (shown in FIG. 1). Build line 26 includes feed tube 28, base block 30, feed channel 32, drive system 34, liquefier assembly 36, and build tip 38, which are arranged in the same manner as disclosed in LaBossiere, et. al., U.S. patent application Ser. No. 11/396,845. Feed tube 28 receives a filament of the modified ABS material (referred to as filament 40) from a supply source (not shown) located externally to build chamber 10 (shown in FIG. 1). Filament 40 extends through feed tube 28 and feed channel 32 of base block 30, thereby allowing drive system 34 to feed filament 40 into liquefier assembly 36.

Drive system 34 includes drive roller 42 and idler roller 44, which are configured to engage and grip filament 40. Drive roller 42 is axially connected to a drive motor (not shown), which allows drive roller 42 and idler roller 44 to feed the filament into liquefier assembly 36. Liquefier assembly 36 includes liquefier block 46 and liquefier channel 48. Liquefier channel 48 is a channel extending through liquefier block 46, which has an entrance adjacent drive system 34, and an exit at build tip 38. Extrusion channel 48 provides a pathway for filament 40 to travel through liquefier block 46. Liquefier block 46 is a heating block for melting the filament to a desired flow pattern based on a thermal profile along liquefier block 46. Build tip 38 is an extrusion tip secured to liquefier assembly 36. Build tip 38 has a tip diameter for depositing roads of the modified ABS material, where the road widths and heights are based in part on the tip diameter. Examples of suitable tip diameters for build tip 38 range from about 250 micrometers (about 10 mils) to about 510 micrometers (about 20 mils).

The modified ABS material is extruded through build line 26 of extrusion head 12 by applying rotational power to drive roller 42 (from the drive motor). The frictional grip of drive roller 42 and idler roller 44 translates the rotational power to a drive pressure that is applied to filament 40. The drive pressure forces successive portions of filament 40 into liquefier channel 48, where the modified ABS material is melted by liquefier block 46. The unmelted portion of filament 40 functions as a piston to force the molten modified ABS material through liquefier channel 48 and build tip 38, thereby extruding the molten modified ABS material. The drive pressure required to force filament 40 into liquefier channel 48 and extrude the molten modified ABS material is based on multiple factors, such as the resistance to flow of the modified ABS material, bearing friction of drive roller 42, the grip friction between drive roller 42 and idler roller 44, and other factors, all of which resist the drive pressure applied to filament 40 by drive roller 42 and idler roller 44.

During a build process, the extrusion flow properties of a build material generally fall within three extrusion phases: (1) a start up phase in which the extrusion flow rate increases from a zero flow rate to a steady-state flow rate, (2) the steady-state phase, and (3) a stopping phase in which the extrusion flow rate decreases from the steady-state flow rate to a zero flow rate. During the steady-state phase, the extrusion flow rate of a build material is the difference between the drive pressure applied to the filament (e.g., filament 40) and the above-discussed resistances to the drive pressure. However, during the start up phase, the build material initially exhibits an additional resistance to extrusion that needs to be exceeded before the build material will extrude. This additional resistance is referred as herein a thixiotropic threshold of the build material.

A higher thixiotropic threshold typically requires a greater amount of drive pressure to start up the extrusion flow. This correspondingly increases the amount of time between when the drive motor applies the rotational power to the drive roller and when the extrusion flow actually starts, thereby limiting the response time of the extrusion head. As discussed above, such response time limitations may reduce the deposition accuracies, which are particularly observable with fine feature structures. Thus, as discussed below, the response time of extrusion head 12 is improved by extruding an modified ABS material under conditions that provide a reduced thixiotropic threshold for the modified ABS material.

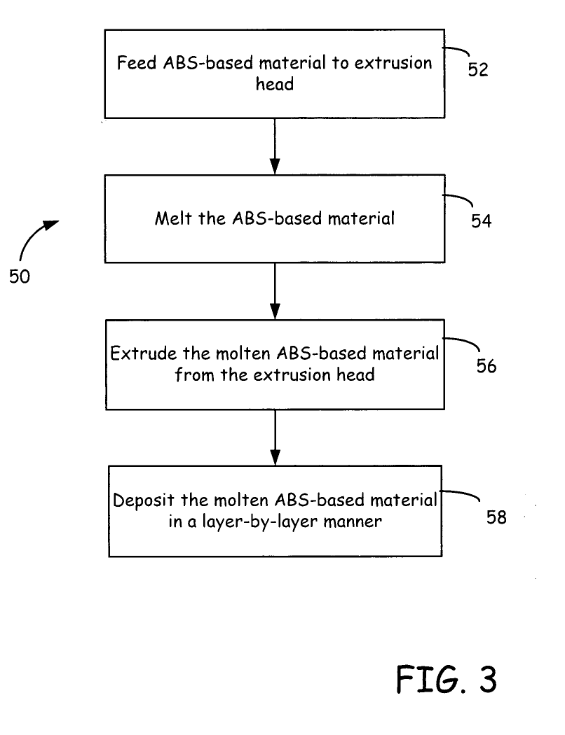

FIG. 3 is a flow diagram of method 50, which is a suitable method for building 3D object 18 (shown in FIG. 1) with an improved response time during a start up phase. Method 50 includes steps 52-58, and initially involves feeding a filament of the modified ABS material to extrusion head 12 (step 52). In one embodiment, the modified ABS material is selected such that the modified ABS material may be extruded at an extrusion rate of 1,000 micro-cubic-inches-per-second (mics) from a standard geometry liquefier at a maximum liquefier temperature with a drive pressure of about 1,000 psi or less.

As used herein, the term “standard geometry liquefier” is defined as a liquefier having a build tip with a liquefier tube inner diameter ranging from 0.0765 inches to 0.075 inches, a total tip length of 3.045+/−0.010 inches, a inner diameter neck length of 0.030+/−0.002 inches, and a tip end landing inner diameter of 0.0.16+/−0.0005 inches. Furthermore, as used herein, the term “maximum liquefier temperature” is defined as the highest liquefier temperature that the modified ABS material can withstand without changing color or flow characteristics for two minutes. Examples of modified ABS materials that meet this criteria include the above-discussed suitable modified ABS materials.

The modified ABS material is then melted within the extrusion head (step 54). As discussed above, the filament of the modified ABS material is fed to liquefier assembly 36 with the use of drive system 34. Liquefier assembly 36 desirably has a liquefier peak temperature that the modified ABS material is thermally stable at, and which reduces the thixiotropic threshold of the modified ABS material. Examples of suitable liquefier peak temperatures for liquefier assembly 36 range from about 280° C. to about 360° C., with particularly suitable temperatures ranging from about 300° C. to about 340° C., and with even more particularly suitable temperatures ranging from about 300° C. to about 320° C.

The molten modified ABS material is then extruded form extrusion head 12 (step 56) and deposited in a layer-by-layer manner to build the three-dimensional object within build chamber 10 (step 58). Suitable environmental temperatures for build chamber 10 range from about 70° C. to about 105° C., with particularly suitable environmental temperatures ranging from about 80° C. to about 95° C. The suitable liquefier peak temperatures and the suitable environmental temperatures are higher than the corresponding temperatures typically used to extrude a standard ABS copolymer. The higher temperatures are beneficial for increasing part strength and reducing porosities in the resulting 3D object 18.

The resulting 3D object 18 has increased deposition accuracies, which are observable by the improved aesthetic quality, particularly at pin feature 22. Thus, the modified ABS material is beneficial for providing high resolution fine feature structures. After being deposited, the modified ABS material in the three-dimensional object is desirably substantially free of thermal degradation. Thermal degradation in a standard ABS copolymer is typically observable as brown-colored streaks in the deposited material.

### EXAMPLES

The present invention is more particularly described in the following examples that are intended as illustrations only, since numerous modifications and variations within the scope of the present invention will be apparent to those skilled in the art. Drive pressures for extrusion runs of Examples 1-12 and Comparative Examples A-D were quantitatively measured to compare the resulting extrusion profiles as a function of liquefier peak temperature and extrusion flow rate. Each extrusion run was performed on a fused deposition modeling system commercially available under the trade designation “FDM TITAN” from Stratasys, Inc., Eden Prairie, Minn. The accompanying extrusion head included a “TITAN” TI build tip with a liquefier tube inner diameter ranging from 0.0765 inches to 0.075 inches, a total tip length of 3.045+/−0.010 inches, and a inner diameter neck length of 0.030+/−0.002 inches.

The extrusion runs of Examples 1-12 were performed with a modified ABS material commercially available under the trade designation “CYCOLAC” MG94-NA1000 ABS from General Electrics Co., Pittsfield, Mass. The extrusion runs of Comparative Examples A-D were performed with a standard ABS copolymer commercially available under the trade designation “AG700 ABS” from The Dow Chemical Company, Midland, Mich. The extrusion runs were performed with different temperatures and extrusion rates, where the extrusion runs of Examples 1-4 were each performed with a tip end landing inner diameter of 0.010 inches, the extrusion runs of Examples 5-8 were each performed with a tip end landing inner diameter of 0.012 inches, and the extrusion runs of Examples 9-12 and Comparative Examples A-D were each performed with a tip end landing inner diameter of 0.016 inches. Table 1 lists the build materials, the tip diameters, and the extrusion rates used for the extrusion runs of Examples 1-12 and Comparative Examples A-D.

TABLE 1

| | | Tip Diameter | Extrusion Rate |
|---|---|---|---|
| Example | Build Material | (inches) | (mics) |
| Example 1 | MG94-NA1000 ABS | 0.010 | 1,000 |
| Example 2 | MG94-NA1000 ABS | 0.010 | 2,000 |
| Example 3 | MG94-NA1000 ABS | 0.010 | 3,000 |
| Example 4 | MG94-NA1000 ABS | 0.010 | 4,000 |
| Example 5 | MG94-NA1000 ABS | 0.012 | 1,000 |
| Example 6 | MG94-NA1000 ABS | 0.012 | 2,000 |
| Example 7 | MG94-NA1000 ABS | 0.012 | 3,000 |
| Example 8 | MG94-NA1000 ABS | 0.012 | 4,000 |
| Example 9 | MG94-NA1000 ABS | 0.016 | 1,000 |
| Example 10 | MG94-NA1000 ABS | 0.016 | 2,000 |
| Example 11 | MG94-NA1000 ABS | 0.016 | 3,000 |
| Example 12 | MG94-NA1000 ABS | 0.016 | 4,000 |
| Comparative | AG700 ABS | 0.016 | 1,000 |
| Example A | | | |
| Comparative | AG700 ABS | 0.016 | 2,000 |
| Example B | | | |
| Comparative | AG700 ABS | 0.016 | 3,000 |
| Example C | | | |
| Comparative | AG700 ABS | 0.016 | 4,000 |
| Example D | | | |

For each extrusion run, a build cycle was commenced to extrude the given build material. The build material was supplied to the extrusion head in filament form (standard filament diameter for “TITAN” TI builds tips, e.g., a diameter of about 0.0707 inches), and was driven by a gear system to a liquefier. The liquefier peak temperature was maintained at a first level (e.g., 240° C.) and the filament was driven until. a steady-state operation was obtained. The power requirements of the drive motor were then quantitatively measured, and the corresponding drive pressure required to extrude the build material was calculated based on the drive motor power requirements. This procedure was then repeated for a variety of different liquefier peak temperatures ranging from 240° C. to 340° C.

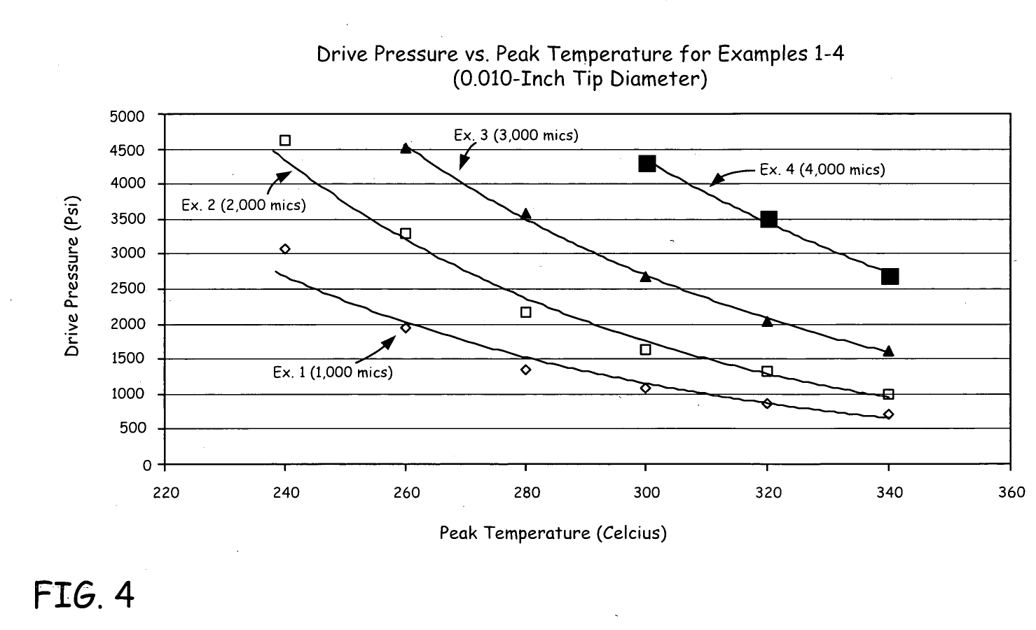

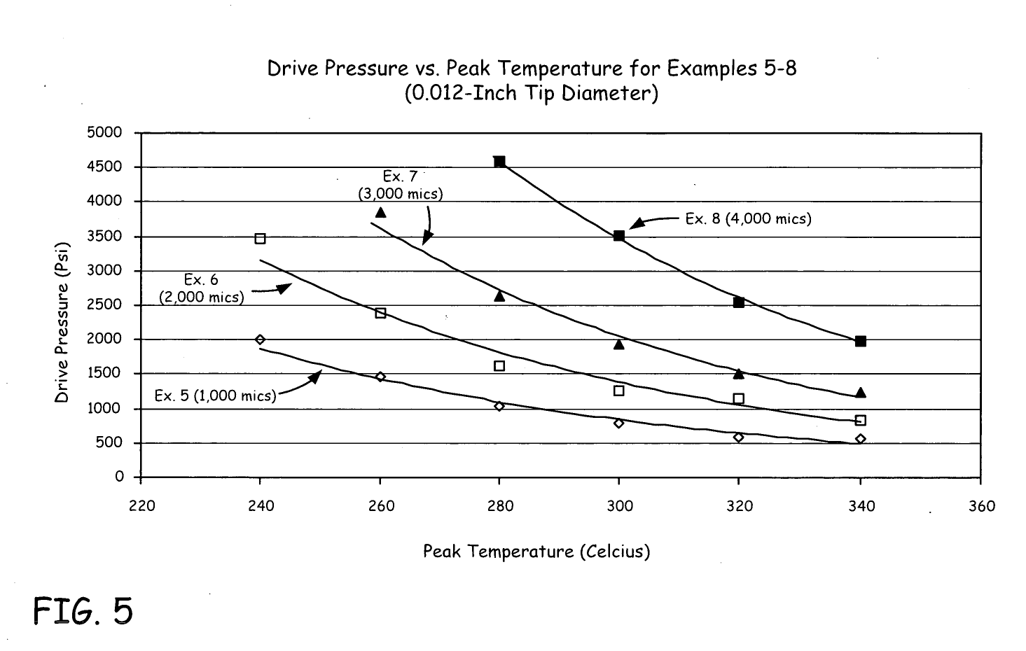

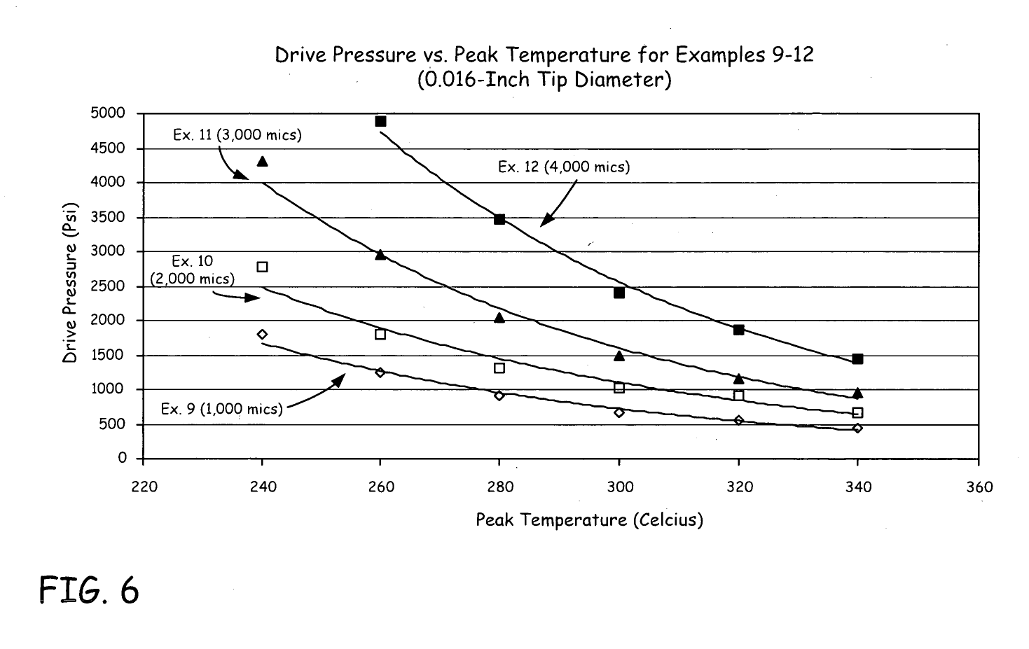

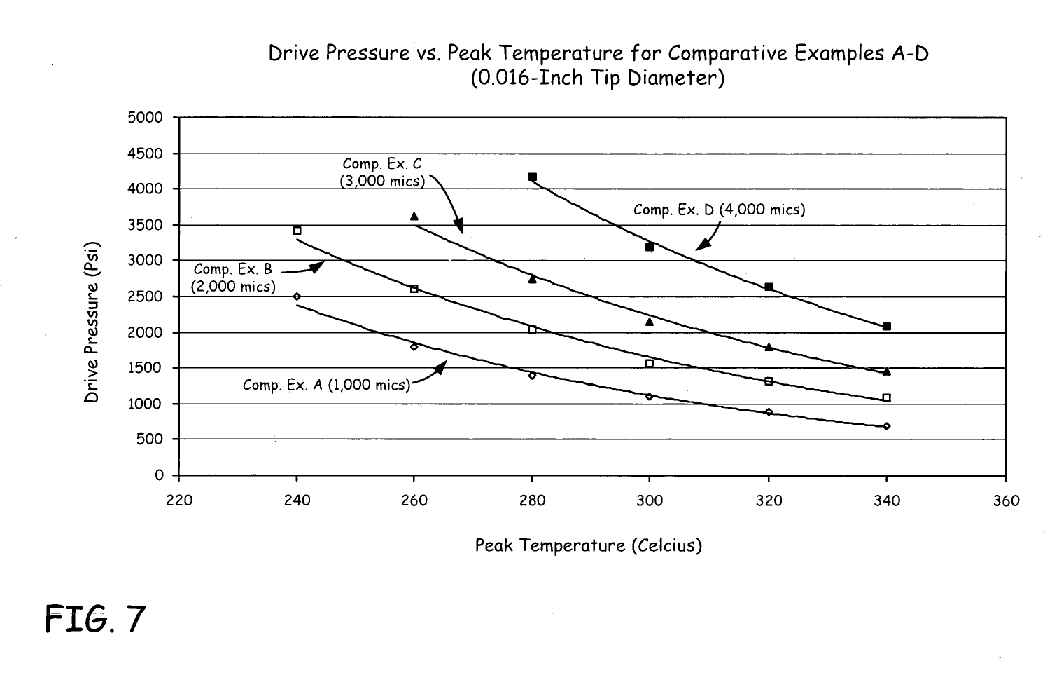

FIGS. 4-7 are graphical representations of drive pressures versus extrusion rates for the extrusion runs of Examples 1-12 and Comparative Examples A-D. A comparison of FIGS. 4-6 shows that the drive pressures decrease with increases in the liquefier peak temperatures, with decreases in tip diameters, and with increases in the extrusion rates, as expected. However, a comparison of the extrusion runs of Examples 9-12 (shown in FIG. 6) and of the extrusion runs of Comparative Examples A-D (shown in FIG. 7) shows that for comparable conditions, the modified ABS material suitable for use with the present invention (MG94-NA1000 ABS) was extrudable at lower drive pressures compared to the standard ABS (AG700 ABS).

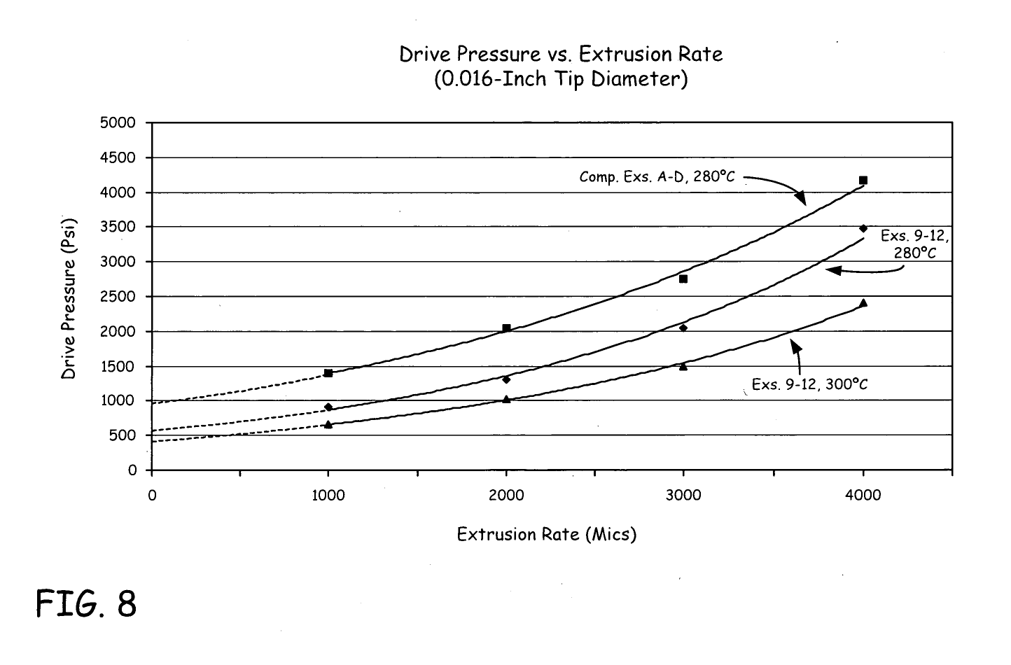

FIG. 8 is an alternative graphical representation of the data provided in FIGS. 6 and 7, which is provided as drive pressure versus extrusion rate for the extrusion runs of Comparative Examples A-D at 280° C., the extrusion runs for Examples 9-12 at 280° C., and the extrusion runs for Examples 9-12 at 300° C. The standard ABS copolymer for Examples A-D is not thermally stable at temperatures above about 290° C., and tends to thermally degrade. As such, the extrusion runs of Examples A-D at 300° C. were not compared.

As shown in FIG. 8, the extrusion runs for Examples 9-12 at 280° C. and 300° C. were performed with lower drive pressures than those obtained from the extrusion runs of Comparative Examples A-D at 280° C. In addition, the exponential regression lines of the extrusion runs were extrapolated to a zero flow rate (i.e., intersecting the y-axis), as shown with broken lines for each extrusion run. The drive pressures at the intersections of the y-axis correspond to the thixiotropic thresholds of the build materials for the corresponding liquefier peak temperatures. As such, at a liquefier peak temperature of 280° C., which is a suitable temperature for extruding the standard ABS copolymer used for Comparative Examples A-D, the standard ABS copolymer had a thixiotropic threshold of about 980 psi. In comparison, the modified ABS material used for Examples 9-12 had a thixiotropic threshold of about 560 psi at a liquefier peak temperature of 280° C. Furthermore, for a liquefier peak temperature of 300° C., which is a desirable temperature for extruding the modified ABS material used for Examples 9-12, the modified ABS material had a thixiotropic threshold of about 430 psi.

Accordingly, the modified ABS material flow characteristics are closer to a Newtonian flow compared to the standard ABS copolymer. A material exhibiting a Newtonian flow would exhibit a linear extrusion run profile and would intersect the y-axis at zero drive pressure (i.e., no thixiotropic threshold). The extrusion run profiles shown in FIG. 8 exhibit exponential trends due to several factors, such as the wetting doughnuts in the liquefiers were closer to the build tips, the build materials were in solid states for longer periods in the liquefier, and the shear layers were pushed closer to the liquefier walls.

Quantitatively, the modified ABS material had a thixiotropic threshold less than about 60% of the thixiotropic threshold of the standard ABS copolymer at a liquefier peak temperature of 280° C. Additionally, when comparing suitable temperatures for extruding the materials (i.e., 280° C. for the standard ABS copolymer, and 300° C. for the modified ABS material), the modified ABS material had a thixiotropic threshold less than about 50% of the thixiotropic threshold of the standard ABS copolymer. As such, an extrusion head would need to produce more than twice as much static drive pressure to start up the extrusion flow of the standard ABS copolymer compared to the modified ABS material. Accordingly, the use of the modified ABS material under the above-discussed operating conditions improves the response time of the extrusion process, thereby increasing deposition accuracy when building 3D objects.

Although the present invention has been described with reference to preferred embodiments, workers skilled in the art will recognize that changes may be made in form and detail without departing from the spirit and scope of the invention.

1. A method for building a three-dimensional object with an extrusion-based layered deposition system, the method comprising:
feeding a filament of a modified acrylonitrile-butadiene-styrene (ABS) material to an extrusion head of the extrusion-based layered deposition system, the modified ABS material requiring a drive pressure of about 1,000 psi or less when extruded at an extrusion rate of 1,000 mics from a standard geometry liquefier at a maximum liquefier temperature;
melting the fed modified ABS material in the extrusion head; and
depositing the molten modified ABS material in a layer-by-layer manner to form the three-dimensional object.

2. The method of claim 1, wherein the required drive pressure is about 750 psi or less.

3. The method of claim 1, wherein the modified ABS material comprises methylmethacrylate.

4. The method of claim 1, wherein melting the fed modified ABS material in the extrusion head comprises melting the fed modified ABS material at a peak temperature ranging from about 300° C. to about 340° C.

5. The method of claim 4, wherein the peak temperature ranges from about 300° C. to about 320° C.

6. The method of claim 4, wherein the three-dimensional object comprises a multi-layer feature having at least one cross-section dimension of about 120 mils or less.

7. The method of claim 1, wherein the deposited modified ABS material is substantially free of thermal degradation.

8. The method of claim 1, wherein the melted modified ABS material has a thixiotropic threshold that is less than a thixiotropic threshold of a standard ABS copolymer when extruded under same conditions.

9. A method for building a three-dimensional object with an extrusion-based layered deposition system, the method comprising:
feeding a modified acrylonitrile-butadiene-styrene (ABS) material to an extrusion head of the extrusion-based layered deposition system;
melting the fed modified ABS material within the extrusion head at a peak temperature ranging from about 300° C. to about 340° C.;
extruding the molten modified ABS material from the extrusion head; and
depositing the molten modified ABS material in a layer-by-layer manner to build the three-dimensional object, wherein the molten modified ABS material in the three-dimensional object is substantially free of thermal degradation.

10. The method of claim 9, wherein the peak temperature ranges from about 300° C. to about 320° C.

11. The method of claim 9, wherein the modified ABS material comprises methylmethacrylate.

12. The method of claim 9, wherein the molten modified ABS material is deposited in a build chamber of the extrusion-based layered deposition system, the build chamber having an environmental temperature ranging from about 70° C. to about 105° C.

13. The method of claim 12, wherein the environmental temperature of the build chamber ranges from about 80° C. to about 95° C.

14. The method of claim 9, wherein the three-dimensional object comprises a multi-layer feature having at least one cross-section dimension of about 120 mils or less.

15. A method for building a three-dimensional object with an extrusion-based layered deposition system, the method comprising:
feeding a modified acrylonitrile-butadiene-styrene (ABS) material to an extrusion head of the extrusion-based layered deposition system;
melting the fed modified ABS material within the extrusion head at a peak temperature that provides a thixiotropic threshold for the modified ABS material that is about 60% or less of a thixiotropic threshold for a standard ABS copolymer melted at the peak temperature;
extruding the molten modified ABS material from the extrusion head; and
depositing the molten modified ABS material in a layer-by-layer manner to build the three-dimensional object wherein the deposited modified ABS material is substantially free of thermal degradation.

16. The method of claim 15, wherein the modified ABS material comprises methylmethacrylate.

17. The method of claim 15, wherein the three-dimensional object comprises a multi-layer feature having at least one cross-section dimension of about 120 mils or less.

18. The method of claim 15, wherein the peak temperature ranges from about 300° C. to about 340° C.

19. The method of claim 15, wherein the molten modified ABS material is deposited in a build chamber of the extrusion-based layered deposition system, the build chamber having an environmental temperature ranging from about 70° C. to about 105° C.

20. The method of claim 19, wherein the environmental temperature of the build chamber ranges from about 80° C. to about 95° C.
